(19) United States
(12) Patent Application Publication
(10) Pub. No.: US 2012/0041620 A1
(43) Pub. Date: Feb. 16, 2012

(54) SYSTEMS AND METHODS FOR PROVIDING SPOOF DETECTION

(76) Inventors: Gregory T. Stayton, Peoria, AZ (US); Mark D. Smith, Glendale, AZ (US); Heidi A. Tomooka, Phoenix, AZ (US)

(21) Appl. No.: 13/206,369

(22) Filed: Aug. 9, 2011

Related U.S. Application Data
(60) Provisional application No. 61/372,395, filed on Aug. 10, 2010.

(51) Int. Cl. G06F 17/00

(52) U.S. Cl. 701/3

(57) ABSTRACT

Spoof detection can be performed by various systems and methods. The systems and methods can provide for detection by passive listening, active interrogation, and other techniques. Moreover, systems and methods can also provide for reporting and displaying information relating to detected spoofing. For example, a method can include receiving, on a device, a signal providing a report for an aircraft. The method can also include determining, with the device, a first parameter for the aircraft from information in the report. The method can further include determining, with the device, a second parameter for the aircraft from at least one signal characteristic of the signal. The method can additionally include determining, with the device, a validity status of the report based on comparing the first parameter and the second parameter.

### CROSS REFERENCE TO RELATED APPLICATIONS

This application is related to and claims the priority of U.S. Provisional Patent Application No. 61/372,395, filed Aug. 10, 2010, the entirety of which incorporated herein by reference.

### BACKGROUND

1. Field

Spoof detection can be performed by various systems and methods. The systems and methods can provide for detection by passive listening, active interrogation, and other techniques. Moreover, systems and methods can also provide for reporting and displaying information relating to detected spoofing.

2. Description of the Related Art

The Federal Aviation Administration (FAA) Next Generation Air Transportation System (NextGen) program is designed to make use of Automatic Dependent Surveillance Broadcast (ADS-B) as a primary source of surveillance for airborne aircraft. This surveillance method can replace the current secondary surveillance radar methodology being used. The current secondary surveillance radar relies on a radar interrogation of an airborne aircraft transponder that replies after a fixed delay. The total round trip time for a reply, minus the fixed delay, is used to calculate the range to the airborne aircraft.

ADS-B typically broadcasts at least aircraft position, aircraft velocity, aircraft ID and aircraft intent and status information at a nearly fixed update rate that provides any receiver information about the aircraft without the need to interrogate. See DO-260B, which is incorporated herein by reference, for more information on the ADS-B surveillance link. Because the ADS-B standards are readily available to the public, various methods of “spoofing” ADS-B data could be attempted. For example, one trying to “spoof” ADS-B data could attempt to do so by providing false aircraft position, aircraft velocity, aircraft ID, aircraft intent and status information or any other ADS-B data.

This spoofing could be disruptive to Air Traffic Control (ATC), potentially resulting in flight delays, a range of safety concerns including aircraft collision and a host of other potential issues. Thus, there is a need for systems and methods for providing ADS-B spoof detection.

### SUMMARY

A method according to certain embodiments includes receiving, on a device, a signal providing a report for an aircraft. The method also includes determining, with the device, a first parameter for the aircraft from information in the report. The method further includes determining, with the device, a second parameter for the aircraft from at least one signal characteristic of the signal. The method additionally includes determining, with the device, a validity status of the report based on comparing the first parameter and the second parameter.

In certain embodiments, a system includes at least one processor and at least one memory including computer program instructions. The at least one memory and the computer program instructions are configured to, with the at least one processor, cause the system at least to receive a signal providing a report for an aircraft. The at least one memory and the computer program instructions are also configured to, with the at least one processor, cause the system at least to determine a first parameter for the aircraft from information in the report. The at least one memory and the computer program instructions are further configured to, with the at least one processor, cause the system at least to determine a second parameter for the aircraft from at least one signal characteristic of the signal. The at least one memory and the computer program instructions are additionally configured to, with the at least one processor, cause the system at least to determine a validity status of the report based on comparing the first parameter and the second parameter.

A method includes, in certain embodiments, receiving, with a first device, a report regarding an aircraft. The method also includes determining, with the first device, a validity status of the report. The method further includes reporting the validity status of the report from the first device to a second device remote from the first device.

A system includes at least one processor and at least one memory including computer program instructions in certain embodiments. The at least one memory and the computer program instructions are configured to, with the at least one processor, cause the system at least to receive a report regarding an aircraft. The at least one memory and the computer program instructions are also configured to, with the at least one processor, cause the system at least to determine a validity status of the report. The at least one memory and the computer program instructions are further configured to, with the at least one processor, cause the system at least to report the validity status from a first device to a second device remote from the first device.

In certain embodiments, a method includes receiving, on own aircraft, a report regarding an aircraft. The method also includes determining a validity status of the report. The method further includes displaying and/or aurally annunciating the validity status of the report to an operator of the own aircraft.

A system, according to certain embodiments, includes at least one processor and at least one memory including computer program instructions. The at least one memory and the computer program instructions are configured to, with the at least one processor, cause the system at least to receive, on own aircraft, a report regarding an aircraft. The at least one memory and the computer program instructions are also configured to, with the at least one processor, cause the system at least to determine a validity status of the report. The at least one memory and the computer program instructions are further configured to, with the at least one processor, cause the system at least to display and/or aurally annunciate the validity status of the report to an operator of the own aircraft.

A method, in certain embodiments, includes receiving, on a device, a signal providing a report for an aircraft. The method also includes determining, with the device, a first parameter for the aircraft from information in the report. The method further includes determining, with the device, a second parameter for the aircraft from a time of arrival of the signal. The method additionally includes determining, with the device, a validity status of the report based on comparing the first parameter and the second parameter.

In certain embodiments, a system includes at least one processor and at least one memory including computer program instructions. The at least one memory and the computer program instructions are configured to, with the at least one processor, cause the system at least to receive a signal providing a report for an aircraft. The at least one memory and the computer program instructions are also configured to, with the at least one processor, cause the system at least to determine a first parameter for the aircraft from information in the report. The at least one memory and the computer program instructions are also configured to, with the at least one processor, cause the system at least to determine a second parameter for the aircraft from a time of arrival of the signal. The at least one memory and the computer program instructions are further configured to, with the at least one processor, cause the system at least to determine a validity status of the report based on comparing the first parameter and the second parameter.

### BRIEF DESCRIPTION OF THE DRAWINGS

For proper understanding of the invention, reference should be made to the accompanying drawings, wherein:

FIG. 1 illustrates an embodiment of bearing and/or bearing rate mitigation of spoofing.

FIG. 2 illustrates confirmation and reporting of a spoof aircraft according to certain embodiments of the present invention.

FIG. 3 illustrates an embodiment of interrogation mitigation of spoofing according to certain embodiments of the present invention.

FIG. 4 illustrates amplitude mitigation of spoofing according to certain embodiments of the present invention.

FIG. 5 illustrates time-based position mitigation of spoofing according to certain embodiments of the present invention.

FIG. 6 illustrates Doppler mitigation of spoofing according to certain embodiments of the present invention.

FIG. 7 illustrates a method according to certain embodiments of the present invention.

FIG. 8 illustrates an aircraft and system according to certain embodiments of the present invention.

FIG. 9 illustrates another method according to certain embodiments of the present invention.

FIG. 10 illustrates a system according to certain embodiments of the present invention.

FIG. 11 illustrates another method according to certain embodiments of the present invention.

FIG. 12 illustrates a system according to certain embodiments of the present invention.

FIG. 13 illustrates a method according to certain embodiments of the present invention.

### DETAILED DESCRIPTION OF THE PREFERRED EMBODIMENT(S)

Certain embodiments of the present invention provide systems and methods that may be used to determine that an airborne aircraft is actually a falsely reported aircraft, i.e., a “spoof” aircraft. Thus, a spoof aircraft may contrast with a real aircraft. Embodiments of the present invention provide systems and methods that may be used to mitigate false traffic reports provided to a surveillance system that employs, by way of example, Automatic Dependent Surveillance Broadcasts. Certain embodiments of the present invention may be utilized to detect spoof aircraft on other broadcasts, including transponder replies solicited from interrogations; i.e., secondary surveillance, Traffic Information Service Broadcasts and Automatic Dependent Surveillance Re-Broadcasts. Moreover, a surveillance system employing an embodiment of the present invention may be an airborne system or a system on the ground.

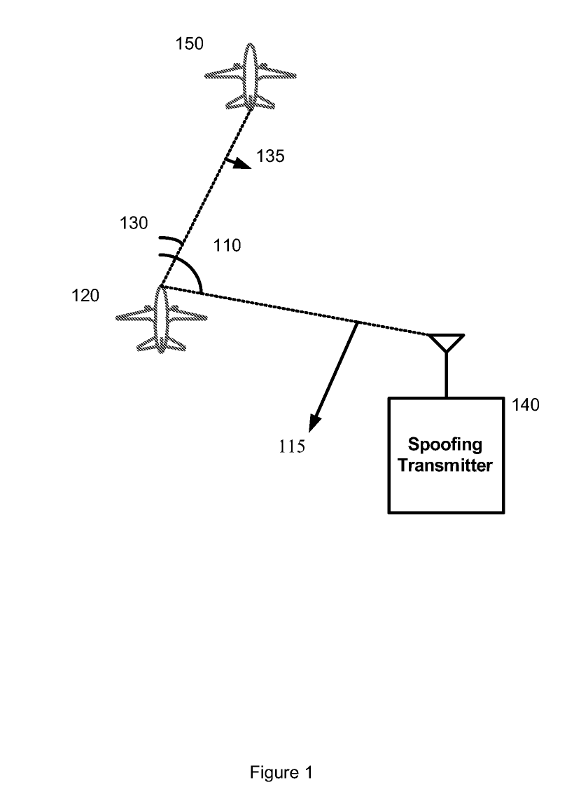

Embodiments of the present invention may use correlation between intruder bearing and/or bearing rate, as measured using a Traffic alert and Collision Avoidance System (TCAS) directional antenna, for example, and intruder bearing and/or bearing rate calculated from received positional data. FIG. 1 illustrates an embodiment of bearing and/or bearing rate mitigation of spoofing.

On an aircraft that is equipped with TCAS and ADS-B (or any other bearing measurement system capable of receiving intruder signals), there may be at least two sources from which intruder bearing and/or bearing rate can be derived with respect to the received ADS-B signal. The data (or parameters) from these two sources can then be used for correlation and verification of an intruder. One source of data that may be used can provide bearing and bearing rate. The bearing and bearing rate can be derived from the bearing measurements reported by the receiving channels through the directional antenna. Conventional TCAS processing may compare the amplitude ratio of the received signals on adjacent channels to determine the bearing of an intruder. This source of data is data about the signal characteristics of the ADS-B signal.

The other type of source of bearing and bearing rate may be the comparison of the GPS source coordinates and velocity of own aircraft compared to the GPS coordinates and velocity reported by the intruder. The bearing and bearing rate generated from these two sources should correlate within a definable limit and when the two reports differ by an amount greater than the limit, an intruder may declared as a potential spoof intruder. It is possible that in the case of an undetected antenna failure, the bearing determined by the directional antenna would contain an error. This can be overcome by any known technique, including those techniques disclosed in U.S. Pat. No. 7,218,277, which is incorporated herein by reference in its entirety.

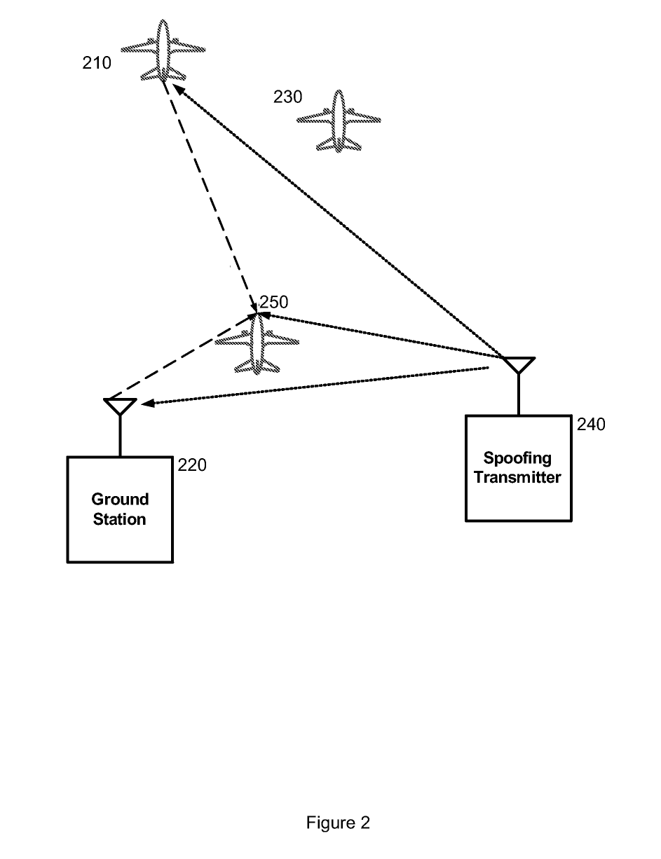

Embodiments of the present invention may use a technique whereby another aircraft or a ground station detects a spoof aircraft and subsequently reports the spoof aircraft to any other entity, including another aircraft or another ground station. FIG. 2 illustrates confirmation of a spoof aircraft according to certain embodiments of the present invention.

Using any or all of the techniques described herein or other techniques, a ground station or aircraft may be used to confirm a suspected spoof aircraft. If enough confidence is gained that the intruder is a spoof, a spoof report could be transmitted from the ground station or aircraft with the spoof coordinates and an indication that the report represents a spoof. This may involve using a bit definition that identifies a reported aircraft as a spoof aircraft. An uplink and a downlink format can be used, such that a spoof aircraft detected by an airborne receiver could also be relayed to the ground station. When the ground station has enough confidence, whether such confidence is based on one or multiple airborne sources, that a spoof aircraft existed, it could then transmit the spoof report to the other airborne systems by means of an Automatic Dependent Surveillance-Report (ADS-R) system. Alternatively, aircraft may communicate directly or indirectly to one another to report a suspect or confirmed spoofing event. Precautions such as private key/public key encryption could be used to prevent the ADS-R system (or other communication system) from being imitated. Thus, the situation could be avoided in which a malicious person declared a real aircraft to be a spoof in order to hide it from display. The use of an authentication technique such as, but not limited, the use of a private key/public key system could also provide aircraft with confidence that the origin of the report they are receiving is authentic. Indeed, such an approach could be used in combination with the techniques described above as an additional parameter to be considered in determining whether a report of a report from an aircraft is from a real aircraft or a spoof aircraft.

Certain embodiments of the present invention may use triangulation based on two or more TCAS-equipped aircraft measured bearings of the spoofed aircraft. Anomalies can then be reported back to at least one of the TCAS-equipped aircraft. FIG. 2 illustrates an example of confirming spoofing by triangulation.

When the bearing determined by the coordinates of the spoof intruder actually does match the bearing determined by the directional antenna, the approach described above in reference to FIG. 1 may not immediately identify the spoof as such. For example, note that in FIG. 2, the false (spoof) aircraft is on approximately the same bearing as the spoofing transmitter with respect to the second aircraft. Accordingly, the second aircraft may not be able to identify the spoofing event without receiving a report from another aircraft or a ground station.

In a typical case, this situation in which the spoof aircraft and the spoofing transmitter have the same bearing with respect to the recipient aircraft will only be a temporary condition. As own (recipient) aircraft continues to move, a difference between the bearing of the spoof aircraft and the spoofing transmitter may increase to the point where the own aircraft can detect the spoof based on its own bearing information alone.

However, the spoof intruder could be detected more quickly if the location of the spoof aircraft were triangulated from two or more aircraft capable of passive listening, as shown in FIG. 2. In this case, a spoof report could be created and transmitted between the aircraft as a means of identifying and validating the potential spoof aircraft. A new intruder reporting format may be created that contains a potential spoof bit and reports the coordinates of the potential spoof aircraft. Even if own aircraft did not identify the spoof as a spoof, the reception of an intruder report from one or two other aircraft which did identify the spoof could accelerate the timeframe in which correct identification could be accomplished.

Alternatively, two aircraft or an aircraft and a ground station could cooperate together by exchanging bearing information regarding a possible spoof aircraft, to triangulate a position of the source of transmission of a possible spoofing event. If a spoofing event is identified, the spoofing event could be reported to the lawful authorities in addition to other aircraft and/or ground stations in the area.

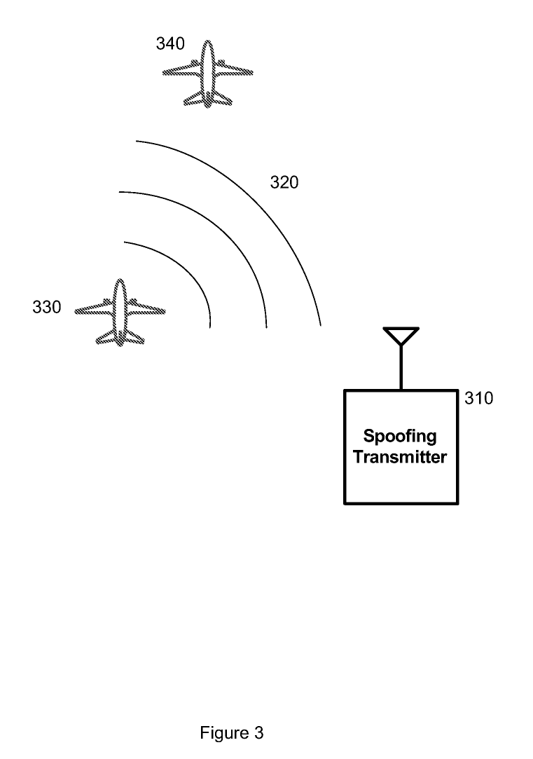

Certain embodiments of the present invention may use active interrogation to verify an ADS-B intruder. FIG. 3 illustrates an embodiment of interrogation mitigation of spoofing according to certain embodiments of the present invention.

Passive squitter (“squitter” is a term that refers to downlink transmissions from a secondary surveillance system, or to reply format transmissions that are sent without being requested, sometimes referred to as “unsolicited replies”) listening has the ability to detect and track an ADS-B equipped intruder at great distances. Typically, active interrogations are performed at shorter distances than passive squitter listening. When an intruder comes within operational range of active interrogations, a TCAS active range measurement can be used to compare the intruder data provided by active interrogations to that received by passive squitter listening and then look for correlation between the two range distances. When the data does not match, the ADS-B intruder detected by passive listening can be identified as an uncorrelated track and have certain display qualities to portray the uncertainty of the track. In some cases, the track can be identified as a spoof track.

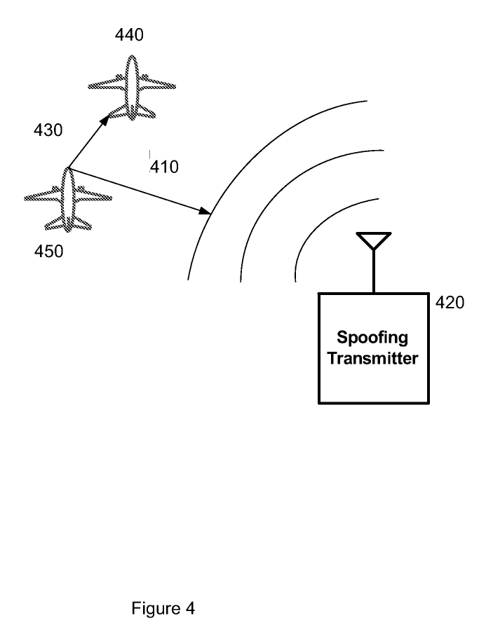

Certain embodiments of the present invention may also use amplitude correlation. FIG. 4 illustrates amplitude mitigation of spoofing according to certain embodiments of the present invention.

Some TCAS systems (such as some available from Aviation Communications and Surveillance Systems (ACSS), which may include a surveillance processor) can be configured to detect the amplitude of an intruder's transmission during reception. While the correlation between an intruder signal amplitude and the intruder range may not be particularly strong, due to potential antenna reflections or blockages, the trend may loosely follow the reported location of the intruder. Thus, if a spoofing transmitter intends to make it appear that the spoof intruder is flying parallel to own aircraft (i.e. the aircraft that the spoofing transmitter is intending to deceive), then it would be unusual for the amplitude to begin changing.

In another example, if the spoof intruder reports its position to be in front of own aircraft, the signal amplitude should increase as the reported range decreases. Amplitude correlation may be less precise than certain other methods for detecting a spoof intruder, it can provide a secondary or alternative way to confirm a suspected spoof intruder. For example, a suspicion that an intruder is a spoof can be generated by one or more of the other techniques described herein and the amplitude monitoring could be used to confirm that suspicion, though this technique could still be employed independently, if desired.

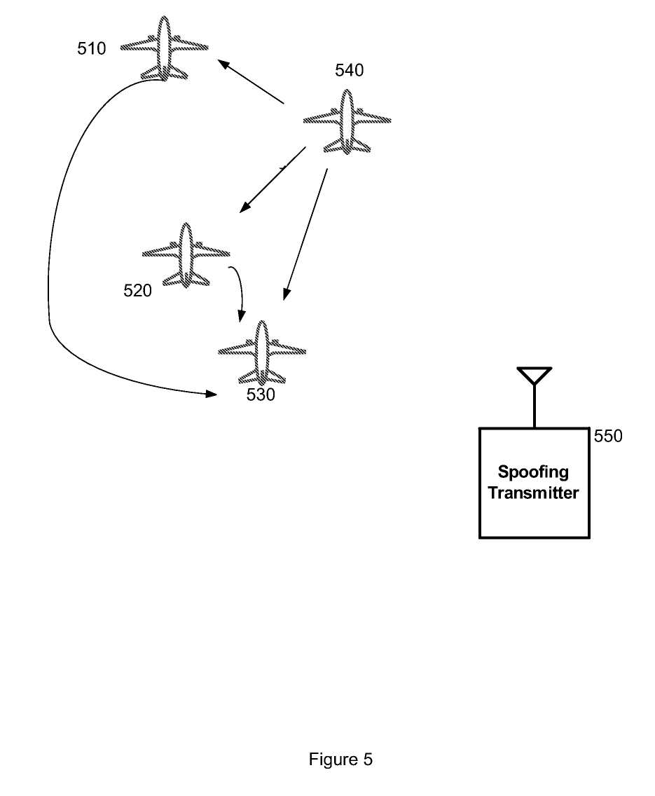

Certain embodiments of the present invention may also use time-based position mitigation of spoofing. FIG. 5 illustrates time-based position mitigation of spoofing according to certain embodiments of the present invention.

A time-based method can be used by two or more aircraft to measure the time that a reply is received to determine the position in space of an aircraft. This may involve the use of a data cross link of information between the group of measuring aircraft, so that each aircraft can derive its own determination of where the spoof aircraft is in space. The reply can be a reply to an interrogation or it can be a so-called unsolicited reply. As shown in FIG. 5, the time-based position measurement can, in the case of a spoof aircraft, yield a different result from the reported position that is being transmitted by the spoofing transmitter. The reason for this difference is that the actual position determined by this technique would be the spoofing transmitter position and not the expected false (“spoof”) aircraft.

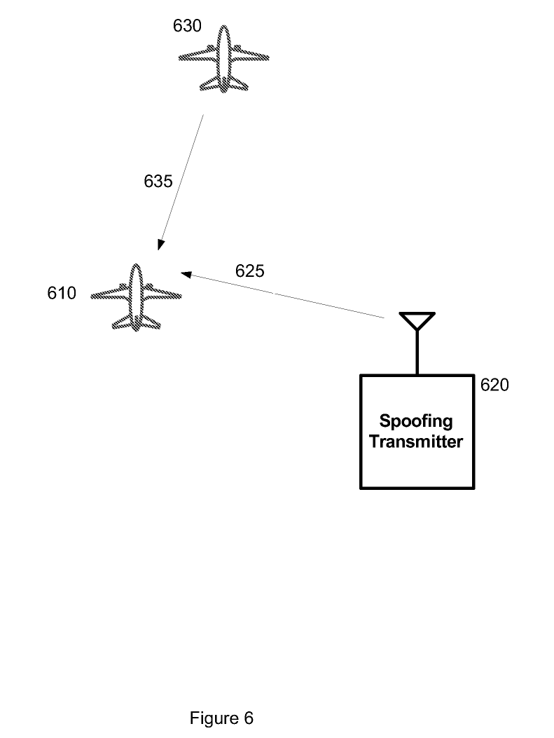

Certain embodiments of the present invention may also or alternatively use Doppler shift to mitigate spoofing. FIG. 6 illustrates Doppler mitigation of spoofing according to certain embodiments of the present invention.

A change in the Doppler shift measurement of the spoofing transmitter can be detected when flying towards or away from the spoofing transmitter that would not be the expected result for an aircraft flight path, as shown in FIG. 6. This measurement can be used to determine that the aircraft is a false, or spoof, aircraft sent from spoofing transmitter. The Doppler measurement can be made by synchronizing to the frequency and phase of the ADS-B 1090 MHz waveform using the four preamble pulses and a number of the first set of data pulses (such as the first four data pulses) to measure the phase drift correction required to maintain synchronization. Then, any change in the phase drift correction amount between successive ADS-B reply updates from that aircraft can be identified. This method of synchronization to the frequency and phase of an ADS-B 1090 MHz reply is described in U.S. patent application Ser. No. 12/455,886, filed Jun. 8, 2009, and entitled SYSTEMS AND METHODS FOR DEMODULATING MULTIPY-MODULATED COMMUNICATIONS SIGNALS, which is incorporated in its entirety herein by reference.

Embodiments of the present invention may also use distinctive symbology to indicate spoof aircraft or related items, such as a spoof transmitter. For example, when any of the spoofing mitigation techniques disclosed herein are used and a spoof aircraft is detected as such, the spoof aircraft detected by passive listening (or any other technique for identifying spoof aircraft) could be identified as an uncorrelated track and have certain display qualities to portray the uncertainty of the track. Additionally, a special symbol could be derived to represent a spoof intruder. This would also be useful for display of any intruders uncorrelated between active and passive detection techniques. The operator may have the ability to turn on or turn off the display of these uncorrelated intruders, and the intruders could be represented by, for example, a less firm symbol (indicating comparative low confidence), like an open symbol or a hollow symbol and/or a using a specified color.

Embodiments of the present invention may also use unique alerting to indicate the detection, presence or any other condition related to a spoof aircraft or other related item. Aural and/or visual alerting may be used to alert the flight crew or provide for situational awareness and appropriate flight plan changes based on the condition that a spoof target has been detected. Additionally, these alerts could be data linked down to or up from the ground, for example, by any technique disclosed in U.S. patent application Ser. No. 12/105,248, filed Apr. 17, 2008, and entitled SYSTEMS AND METHODS FOR PROVIDING AN ATC OVERLAY DATA LINK, which is incorporated in its entirety herein by reference. In this way, the ground will know to ignore the false indications and be able to alert any entity of interest, including flight crews and federal authorities, of the situation.

Certain embodiments of the present invention may also use unique spoof detection criteria. Any of the techniques described herein may be used to detect a spoof aircraft. In some circumstances, it may be desirable to use more than one of the spoof-detection techniques described herein. Accordingly, if desired, a system can be configured such that a spoof aircraft is not confirmed until any combination of two or more of the spoof-detection techniques described herein indicates the presence of a spoof aircraft. Moreover, once a spoof aircraft is confirmed, whether or not by the use of one or more of the spoof-detection techniques described herein, the system may be configured to show the spoof aircraft on a display or not to show the spoof aircraft on a display. However, once a spoof aircraft is confirmed, the system can be configured not to use the spoof aircraft to determine whether any type of collision avoidance action is desired.

Embodiments of the present invention may also use unique logging or recording of spoof detection data. Detected spoof aircraft and its associated state or other data may be recorded for later downloading for analysis by any desired entity including, without limitation, maintenance teams and the lawful authorities. Such data may include, but is not limited to, spoof position, spoof velocity, spoof Mode S address, spoof Flight ID, and any other spoof data, as well as actual detected or calculated position, velocity, bearing, Doppler shift, and any other data parameters that have been measured or received from a spoof transmitter or any other source. Other parameters may include, but are not limited to, data fields defined in RTCA DO-260B, such as but not limited to NIC integrity and NAC accuracy data.

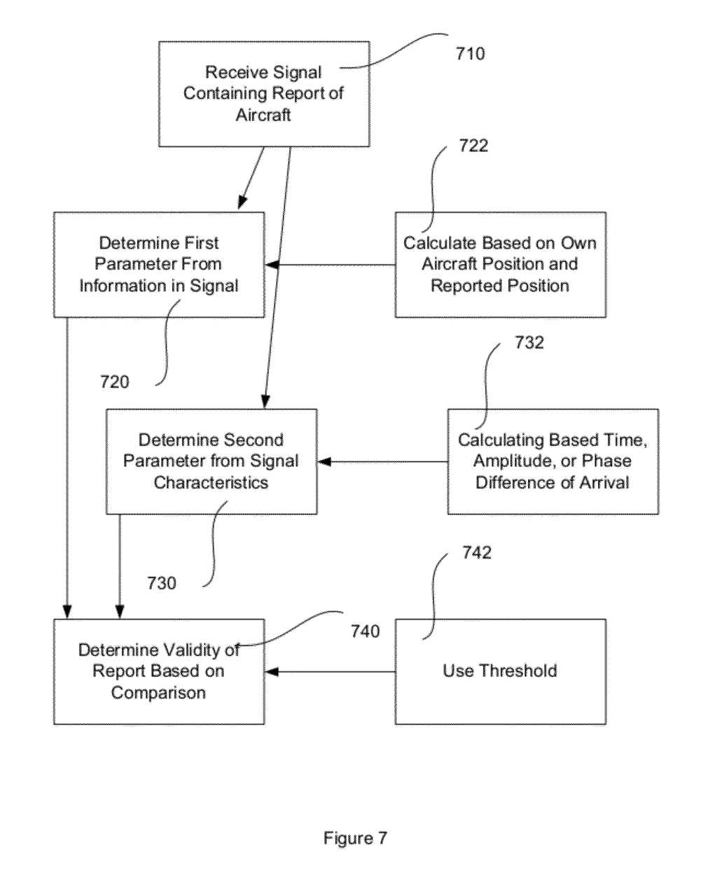

FIG. 7 illustrates a method according to certain embodiments of the present invention. The method includes, at 710, receiving, on a device, a signal providing a report for an aircraft. The device can be located in own aircraft. The report can be or include a position report. The signal can include or encode an ADS-B message. The signal can include a Mode S message, a UAT message, a TIS-B message, or a FIS-B message.

The method of FIG. 7 also includes, at 720, determining, with the device, a first parameter for the aircraft from information in the report. The method can further include, at 730, determining, with the device, a second parameter for the aircraft from at least one signal characteristic of the signal.

The method, as illustrated in FIG. 7, additionally includes, at 740, determining, with the device, a validity status of the report based on comparing the first parameter and the second parameter. Determining the validity status based on the comparing can include, at 742, determining that the report is valid when a difference between the first parameter and the second parameter is less than a predetermined threshold. The validity here can refer to whether or not the report is a spoof report for a non-existent aircraft.

The first parameter and/or the second parameter can include a bearing of the aircraft with respect to own aircraft. Alternatively, or in addition, the first parameter and/or the second parameter comprises a range of the aircraft with respect to own aircraft. Determining the first parameter can include, at 722, calculating a bearing to the aircraft with respect to own aircraft based on a position in the report and a position of own aircraft. Determining the second parameter can include, at 732, calculating a bearing based on a time, amplitude, and/or phase difference of arrival the signal.

The first parameter or the second parameter can be or include at least one of the following: range of the aircraft; range rate of the aircraft; range acceleration of the aircraft; bearing of the aircraft; bearing rate of the aircraft; bearing acceleration of the aircraft; altitude of the aircraft; altitude rate of the aircraft; or altitude acceleration of the aircraft. Any combination of the preceding parameters can correspond to the first and/or second parameter, as well.

The signal characteristic can be or include at least one of the following: radio frequency power level of the signal; differential time measurement of receipt of the signal; or Doppler frequency change of the signal.

RF power level can be used in various ways. For example, RF power level can be used in terms of an expected power level with respect to range. Additionally, or alternatively, however, RF power level can be used with respect to a comparison of the signal strength received by a top antenna and a bottom antenna. If an aircraft is above own aircraft, the top antenna is expected to have a higher signal strength then the bottom antenna, for example, particularly when the aircraft is reported to be close (for example, within one mile) to own aircraft.

Differential time measurement of receipt can be a measurement of the ADS-B unsolicited reply as received by own aircraft and another cooperative aircraft or ground station. Doppler frequency change between own aircraft and the other (spoof) aircraft can also be used, whether based on an acceleration of own aircraft or of the other aircraft.

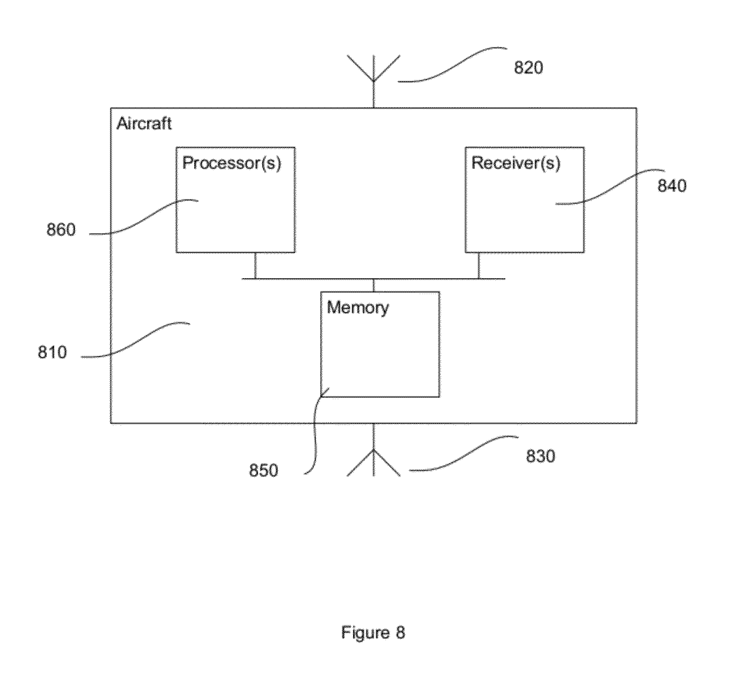

FIG. 8 illustrates an aircraft and system according to certain embodiments of the present invention. As shown in FIG. 8, an aircraft 810 (which can be, for example, an airplane or unmanned aerial vehicle) can include at least one upper antenna 820 and at least one lower antenna 830. Aircraft 810 can be own aircraft. The aircraft 810 can be equipped with a system that includes one or more receivers 840, at least one memory 850 including computer instructions, and at least one processor 860. The system is shown as being interconnected by a bus, but any form of interconnection is permitted. The connections to the upper antenna 820 and lower antenna 830 are not shown, but such connections can be provided. In particular, the receivers 840 can be configured to selectively connected to the upper antenna 820 and lower antenna 830.

The aircraft 810 and the system therein can be configured to perform the methods described above. For example, the aircraft 810 and the system therein can be configured to perform the methods illustrated in FIG. 7. The system described can be incorporated with or into a TCAS or related avionics equipment. Although the system can include the receivers 840, the system can also be separate from the receivers. For example, the system can be operably connected to the receivers and can control the receivers to perform the appropriate monitoring.

The at least one processor 860 can be variously embodied by any computational or data processing device, such as a central processing unit (CPU) or application specific integrated circuit (ASIC). The at least one processor 860 can be implemented as one or a plurality of controllers.

The at least one memory 850 can be any suitable storage device, such as a non-transitory computer-readable medium. For example, a hard disk drive (HDD) or random access memory (RAM) can be used in the at least one memory 850. The at least one memory 850 can be on a same chip as the at least one processor 860, or may be separate from the at least one processor 860.

The computer program instructions may be any suitable form of computer program code. For example, the computer program instructions may be a compiled or interpreted computer program.

The at least one memory 850 and computer program instructions can be configured to, with the at least one processor 860, cause a hardware apparatus (for example, a TCAS system) to perform a process, such as the process shown in FIG. 7 or any other process described herein.

For example, the at least one memory 850 and computer program instructions can be configured to, with the at least one processor 860, cause the apparatus at least to receive a signal providing a report for an aircraft (other than own aircraft 810), determine a first parameter for the aircraft from information in the report, determine a second parameter for the aircraft from at least one signal characteristic of the signal, and determine a validity status of the report based on comparing the first parameter and the second parameter.

Thus, in certain embodiments, a non-transitory computer-readable medium can be encoded with computer instructions that, when executed in hardware perform a process, such as one of the processes described above. Alternatively, certain embodiments of the present invention may be performed entirely in hardware.

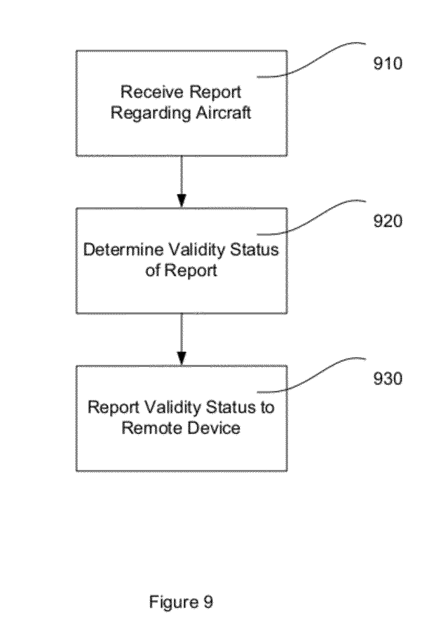

FIG. 9 illustrates another method according to certain embodiments of the present invention. As shown in FIG. 9, a method can include, at 910, receiving, with a first device, a report regarding an aircraft. The report can include a position report. The report can, for example, include an ADS-B message. The first device can be located in own aircraft.

The method can also include, at 920, determining, with the first device, a validity status of the report. The method can further include, at 930, reporting the validity status of the report from the first device to a second device remote from the first device.

The second device can be located in one or more of another aircraft or a receiver on the ground, such as at an air traffic control (ATC) facility. The first device or the second device can be or include a ground station, such as an ATC facility.

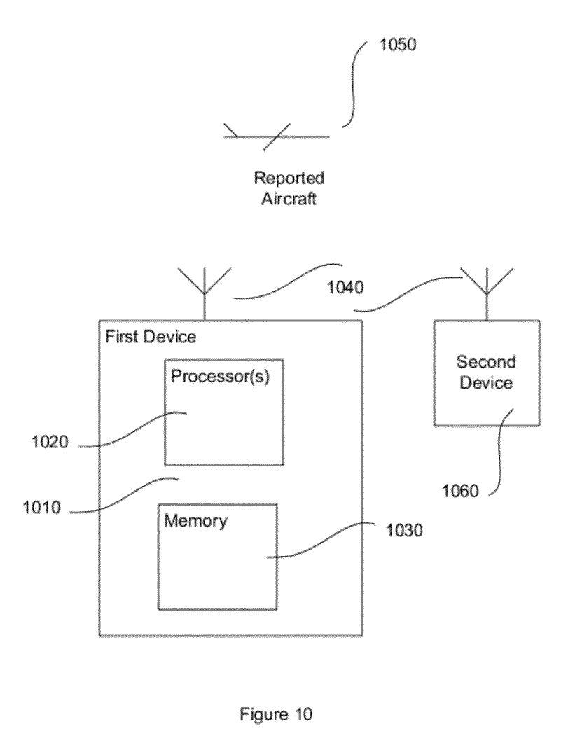

FIG. 10 illustrates a system according to certain embodiments of the present invention. As shown in FIG. 10, a first device 1010 can include at least one processor 1020 and at least one memory 1030 including computer program instructions. The first device 1010 can also include one or more antenna 1040. The at least one memory 1030 and the computer program instructions can be configured to, with the at least one processor, cause the first device 1010 at least to receive and process a report regarding an aircraft 1050, determine a validity status of the report, and report the validity status from the first device 1010 to a second device 1060 remote from the first device 1010. The report can be or include a position report. For example, the report can be, include, or be included in an ADS-B message The first device 1010 can be or be located in own aircraft The second device 1060 can be or be located in one or more of another aircraft or a receiver on the ground, such as an ATC facility. Thus, the first device or the second device can be, include, or be included in a traffic control station, such as a tower or regional ATC facility.

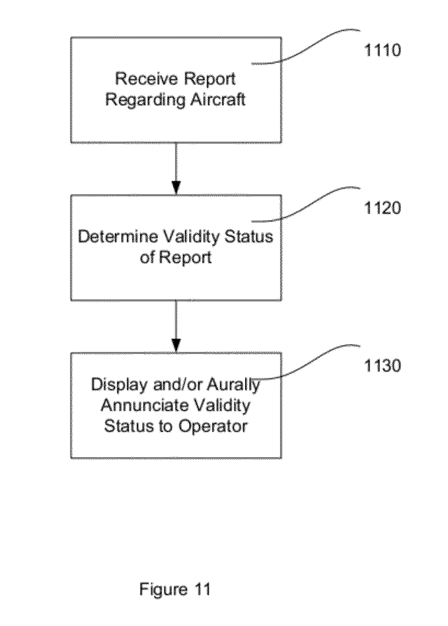

FIG. 11 illustrates another method according to certain embodiments of the present invention. The method illustrated in FIG. 11 includes, at 1110, receiving, on own aircraft, a report regarding an aircraft. The method further includes, at 1120, determining a validity status of the report. The method additionally includes, at 1130, displaying and/or aurally annunciating the validity status of the report to an operator of the own aircraft. In another embodiment, the system embodying this method could be located in ground station and could report (visually and/or aurally) the validity status to an operator of the system, such as an air traffic controller.

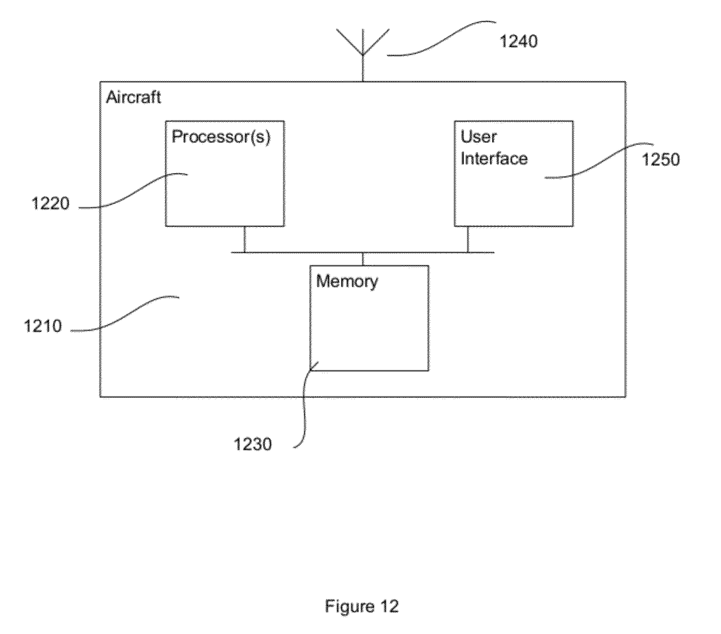

FIG. 12 illustrates a system according to certain embodiments of the present invention. The system of FIG. 12 can be an aircraft 1210 (or system or sub-system thereof, such as a TCAS system). The system can include at least one processor 1220 and at least one memory 1230 including computer program instructions. The at least one memory 1230 and the computer program instructions can be configured to, with the at least one processor 1220, cause the system at least to receive (for example, on antenna 1240 of own aircraft 1210), a report regarding an aircraft, determine a validity status of the report, and display and/or aurally annunciate (via user interface 1250) the validity status of the report to an operator of the own aircraft 1210. The user interface 1250 can include a display, speakers, and any other way of communicating information from a computer system to a user.

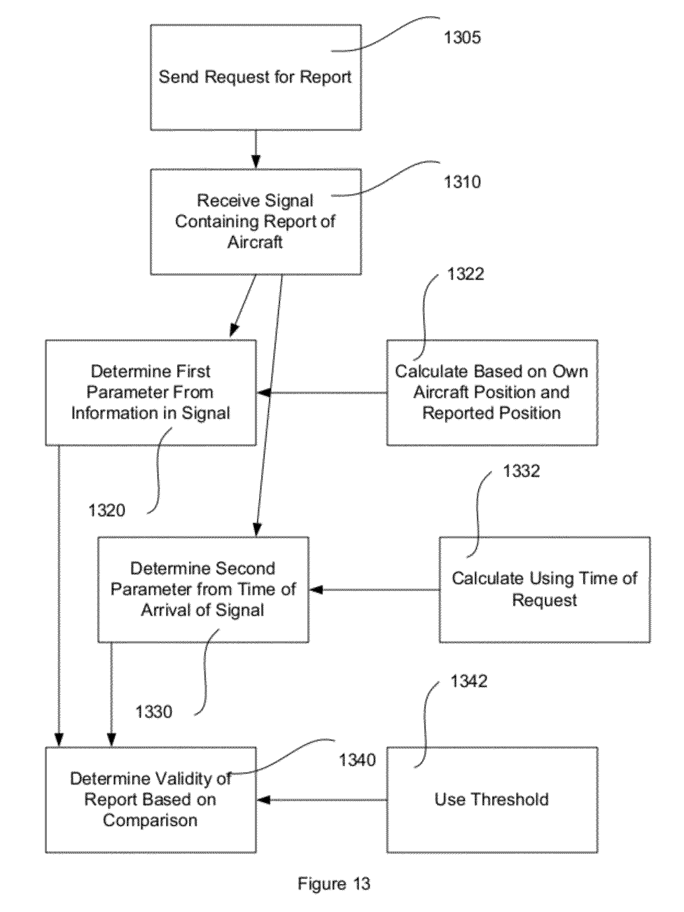

FIG. 13 illustrates a method according to certain embodiments of the present invention. As shown in FIG. 13, a method can include, at 1310, receiving, on a device, a signal providing a report for an aircraft. The method can also include, at 1320, determining, with the device, a first parameter for the aircraft from information in the report. The first parameter can be calculated, at 1322, based on a position of own aircraft and a reported position.

The method can further includes, at 1330, determining, with the device, a second parameter for the aircraft from a time of arrival of the signal. For example, at 1332, the method can calculate a parameter such as range from the time of receipt of a reply relative to an interrogation. Thus, the determining the second parameter can include determining a range of the aircraft based on a time when the request was sent and the time of arrival of the signal.

The method can additionally include, at 1340, determining, with the device, a validity status of the report based on comparing the first parameter and the second parameter.

Prior to receiving the signal providing the report, the method can include, at 1305, sending a request for the report. The request for the report can be an interrogation. The first parameter and/or the second parameter can include a distance between the aircraft and own aircraft. The validity determination can be made by, at 1342, using a threshold to determine whether the range as calculated based on the report corresponds sufficiently to the range as calculated based on time of arrival of the signal. The threshold can be variously configured to be a broad threshold, such as 100 nautical miles, or a narrow threshold, such as 1 nautical mile. Other threshold values can be used.

The method of FIG. 13 can be variously implemented. For example, the method of FIG. 13 can be implemented by the system disclosed in FIG. 8.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
receiving, on a device, a signal providing a report for an aircraft;
determining, with the device, a first parameter for the aircraft from information in the report;
determining, with the device, a second parameter for the aircraft from at least one signal characteristic of the signal; and
determining, with the device, a validity status of the report based on comparing the first parameter and the second parameter.

2. The method of claim 1, wherein the device is comprised in own aircraft.

3. The method of claim 1, wherein the report comprises a position report.

4. The method of claim 1, wherein the signal comprises a signal including an ADS-B message.

5. The method of claim 1, wherein the first parameter and/or the second parameter comprises a bearing of the aircraft with respect to own aircraft.

6. The method of claim 1, wherein determining the first parameter comprises calculating a bearing to the aircraft with respect to own aircraft based on a position in the report and a position of own aircraft.

7. The method of claim 1, wherein determining the second parameter comprises calculating a bearing based on a time, amplitude, and/or phase difference of arrival the signal.

8. The method of claim 1, wherein determining the validity status based on the comparing comprises determining that the report is valid when a difference between the first parameter and the second parameter is less than a predetermined threshold.

9. The method of claim 1, wherein the signal comprises a signal including a Mode S message, a UAT message, a TIS-B message, or a FIS-B message.

10. The method of claim 1, wherein the first parameter and/or the second parameter comprises at least one of the following:
range of the aircraft;
range rate of the aircraft;
range acceleration of the aircraft;
bearing of the aircraft;
bearing rate of the aircraft;
bearing acceleration of the aircraft;
altitude of the aircraft;
altitude rate of the aircraft; or
altitude acceleration of the aircraft.

11. The method of claim 1, wherein the signal characteristic comprises at least one of the following:
radio frequency power level of the signal;
differential time measurement of receipt of the signal; or
Doppler frequency change of the signal.

12. A system, comprising:
at least one processor; and
at least one memory including computer program instructions,
wherein the at least one memory and the computer program instructions are configured to, with the at least one processor, cause the system at least to receive a signal providing a report for an aircraft;
determine a first parameter for the aircraft from information in the report;
determine a second parameter for the aircraft from at least one signal characteristic of the signal; and
determine a validity status of the report based on comparing the first parameter and the second parameter.

13. The system of claim 12, wherein the apparatus is located in own aircraft.

14. The system of claim 12, wherein the report comprises a position report.

15. The system of claim 12, wherein the signal comprises a signal including an ADS-B message.

16. The system of claim 12, wherein the first parameter and/or the second parameter comprises a bearing of the aircraft with respect to own aircraft.

17. The system of claim 12, wherein determining the first parameter comprises calculating a bearing to the aircraft with respect to own aircraft based on a position in the report and a position of own aircraft.

18. The system of claim 12, wherein determining the second parameter comprises calculating a bearing based on a time, amplitude, and/or phase difference of arrival the signal.

19. The system of claim 12, wherein determining the validity status based on the comparing comprises determining that the report is valid when a difference between the first parameter and the second parameter is less than a predetermined threshold.

20. The system of claim 12, wherein the first parameter and/or the second parameter comprises a range of the aircraft with respect to own aircraft.

21. The system of claim 12, wherein the signal comprises a signal including a Mode S message, a UAT message, a TIS-B message, or a FIS-B message.

22. A method, comprising:
receiving, with a first device, a report regarding an aircraft;
determining, with the first device, a validity status of the report; and
reporting the validity status of the report from the first device to a second device remote from the first device.

23. The method of claim 22, wherein the report comprises a position report.

24. The method of claim 22, wherein the report comprises an ADS-B message.

25. The method of claim 22, wherein the first device is located in own aircraft.

26. The method of claim 22, wherein the second device is located in one or more of another aircraft or a receiver on the ground.

27. The method of claim 22, wherein the first device or the second device comprises a ground station.

28. A system, comprising:
at least one processor; and
at least one memory including computer program instructions,
wherein the at least one memory and the computer program instructions are configured to, with the at least one processor, cause the system at least to
receive a report regarding an aircraft;
determine a validity status of the report; and
report the validity status from a first device to a second device remote from the first device.

29. The system of claim 28, wherein the report comprises a position report.

30. The system of claim 28, wherein the report comprises an ADS-B message.

31. The system of claim 28, wherein the first device is located in own aircraft.

32. The system of claim 28, wherein the second device is located in one or more of another aircraft or a receiver on the ground.

33. The system of claim 28, wherein the first device or the second device comprises a traffic control station.

34. A method, comprising:
receiving, on own aircraft, a report regarding an aircraft;
determining a validity status of the report; and
displaying and/or aurally annunciating the validity status of the report to an operator of the own aircraft.

35. A system, comprising:
at least one processor; and
at least one memory including computer program instructions,
wherein the at least one memory and the computer program instructions are configured to, with the at least one processor, cause the system at least to
receive, on own aircraft, a report regarding an aircraft;
determine a validity status of the report; and
display and/or aurally annunciate the validity status of the report to an operator of the own aircraft.

36. A method, comprising:
receiving, on a device, a signal providing a report for an aircraft;
determining, with the device, a first parameter for the aircraft from information in the report;
determining, with the device, a second parameter for the aircraft from a time of arrival of the signal; and
determining, with the device, a validity status of the report based on comparing the first parameter and the second parameter.

37. The method of claim 36, further comprising:
prior to receiving the signal providing the report, sending a request for the report.

38. The method of claim 37, wherein the determining the second parameter comprises determining a range of the aircraft based on a time when the request was sent and the time of arrival of the signal.

39. The method of claim 37, wherein the first parameter and/or the second parameter comprises a distance between the aircraft and own aircraft.

40. A system, comprising:
at least one processor; and
at least one memory including computer program instructions,
wherein the at least one memory and the computer program instructions are configured to, with the at least one processor, cause the system at least to
receive a signal providing a report for an aircraft;
determine a first parameter for the aircraft from information in the report;
determine a second parameter for the aircraft from a time of arrival of the signal; and
determine a validity status of the report based on comparing the first parameter and the second parameter.
